(19) United States
(12) Patent Application Publication
(10) Pub. No.: US 2005/0083454 A1
(43) Pub. Date: Apr. 21, 2005

(54) Optical reflector and display device using it

(76) Inventor: Naoki Sumi, Nishi-ku (JP)

Correspondence Address: Philips Electronics North America Corporation;Intellectual Property & Standards, 1109 McKay Drive, M/S41-SJ, San Jose, CA, 95131, US

(21) Appl. No.: 10/491,801

(22) PCT Filed: Oct. 3, 2002
(86) PCT No.: PCT/IB02/04089

(30) Foreign Application Priority Data
Oct. 4, 2001 (JP) 2001-308737

(51) Int. Cl. G02F 1/1335

(52) U.S. Cl. 349/113

(57) ABSTRACT

It is an object of the invention is to provide an optical reflector having a directivity of reflection and a display device using it. Depressions of a projection/depression forming member (46) is relatively spread in the right-and-left direction of a display surface. The depressions of the member (46) are provided in such a manner that their average diameter in the right-and-left direction of the display surface is larger than that in the up-and-down direction of the display surface and their average pitch in the right-and-left direction of the display surface is greater than that in the up-and-down direction of the display surface. When a light enters into a surface of a reflective film (48), the light is reflected in the up-and-down direction more selectively. Therefore, with an observation of the display surface from a predetermined direction, a utilization efficiency of the incident light can be enhanced, so that display performance of the display device such as a brightness and a contrast can be improved.

### BACKGROUND OF THE INVENTION

1. Field of the Invention

This invention relates to an optical reflector having a reflecting surface with depressions and projections, which are formed to follow the profile of a plurality of depressions or projections of a projection/depression forming member, and also relates to a display device using such an optical reflector.

2. Description of Related Art

In recent years, a flat panel display typified by a liquid crystal display device has been becoming widespread rapidly. Examples of the liquid crystal display devices include the transmission-type device which is provided with a light source (backlight) behind a display cell and uses a light from the light source thereby to perform a display, and the reflection-type device which is provided with a reflector and uses a reflected light caused by reflecting surrounding light incident through a surface of a display panel by the reflector to carry out a display. The reflection-type device allows its electrical power consumption to be reduced to a larger extent than that of the transmission-type device and therefore, has received attention as a display device used for, in particular, portable electronic equipment.

The reflective device display performs a display using incident light from the surroundings and therefore, is required to effectively use the incident light thereby to obtain a sufficiently well-lit display for practical use. For this reason, the reflector generally has a surface with depressions and projections thereby to cause the incident light to reflect diffusely. Conventionally, in most cases, in order to control the angle that the incident light makes with the reflecting surface for reflection, the projections of the reflecting surface of the reflector are provided so that they have a predetermined tilt angle relative to the main surface of a substrate and each of them has a symmetrical shape (for example, a circle or an regular polygon), with the reflecting surface being viewed from above, so as to reflect the light uniformly in all directions. Since the regularly arranged projections result in the problem of coloring, the projections are generally patterned in a random order.

However, when a display surface of the device is viewed from a specific angle relative to the main surface of the substrate, a problem is caused that reflection of the light reflected uniformly in all directions as described above may reduce utilization efficiency of the incident light. More specifically, for example, when viewing a display of a portable telephone, a viewer in many cases views the display from a position approximately vertical to a surface of the display and therefore, an disadvantage is caused that the reflected light scattered in a direction approximately parallel to the display surface cannot effectively be utilized.

### SUMMARY OF THE INVENTION

The invention has been made in view of the above-mentioned problems and has an object to provide an optical reflector having a directivity of reflection and a display device using it.

An optical reflector or a display device according to the invention comprises a projection/depression forming member provided on one surface of a support member and having a plurality of depressions or projections which are spaced apart from each other, a reflective film provided so as to cover the projection/depression forming member and having a reflecting surface with depressions and projections formed to follow the profile of the depressions or projections of the projection/depression forming member, in which an average diameter of the plurality of depressions or projections of the projection/depression forming member in a first direction is larger than that in a second direction perpendicular to the first direction and the plurality of depressions or projections of the projection/depression forming member are provided in such a manner that an average pitch thereof in the first direction is greater than that in the second direction. It should be understood that the expressions “first direction” and “second direction” used herein mean two directions perpendicular to each other on a plane parallel to said one surface of the support member, i.e., on a plane orthogonal to a direction where the projection/depression forming member and the reflective film are laminated. In addition, “pitch” means a distance between the centers of depressions or projections adjacent to each other.

With the optical reflector or the display device according to the invention, since said average diameter and said average pitch in the first direction are larger than those in the second direction, the depressions and projections of the projection/depression forming member are formed relatively wider in the first direction than that in the second direction. As a result, an amount of light reflected in the first direction This means that the ratio of an amount of light reflected in the first direction to an amount of light incident on the optical reflector is smaller and the ratio of an amount of light reflected in the second direction to the same is larger. Thus, the reflective film reflects the light incident thereon with a directivity of reflection.

The optical reflector or the display device according to the invention preferably comprises a projection/depression adjustment film provided between the projection/depression forming member and the reflective film to adjust the depressions and projections of the reflecting surface. Interposing the projection/depression adjustment film makes it possible to easily achieve a desired projection/depression profile of the reflecting surface of the reflective film.

Another optical reflector or a display device according to the invention comprises a projection/depression forming member of an organic material provided on one surface of a support member and having projections or depressions which make a substantially polygonal mesh pattern of said projection/depression forming member, and a reflective film provided so as to cover said projection/depression forming member and having a reflecting surface with projections or depressions formed under the influence of the projections or depressions of said projection/depression forming member, in which a width of the projections or depressions of the projection/depression forming member in a first region where any direction forms a predetermined angle with one direction in plane with a plane parallel to the one surface of the support member and that in a second region other than the first region in plane with the plane parallel to the one surface of the support member are different from each other. It should be understood that the expressions “substantially polygonal” used herein includes the case where corners of each depressions or projections formed by the projections or depressions of the said projection/depression member are slightly round.

With the other optical reflector or the display device according to the invention, since the width of the projections or depressions of the projection/depression forming member in the first region and that in the second region are different, a height of the projections of the projection/depression forming member or a depth of the depressions of the projection/depression forming member in the first region is made also different to that in the second region, whereby the shape of the projections and depressions for the reflecting surface of the reflective film is controlled. Consequently, the reflective film reflects the light incident thereon with a directivity of reflection.

Said one direction, more specifically, is orthogonal to a direction to which a larger amount of light rays are to be reflected on the reflecting surface of the reflective film. In that case, the width of the projections or depressions of the projection/depression forming member in the first region is selected to be larger than that in the second region. Preferably, said predetermined angle is determined in accordance with a ration of the average pitch of the depressions or projections of the projection/depression forming member in the one direction to that in an orthogonal direction orthogonal to said one direction. It should be noted that the expressions “one direction” and “orthogonal direction” used herein means two directions perpendicular to each other on a plane parallel to said one surface of the support member, i.e., on a plane orthogonal to a direction where the projection/depression forming member and the reflective film are laminated.

Other and further objects, features and advantages of the invention will appear more fully from the following description.

### BRIEF DESCRIPTION OF THE DRAWINGS

FIGS. 1A to 1E are schematic cross sections each showing a manufacturing step of an optical reflector according to a first embodiment of the invention.

FIG. 2 is a plan view of an example of a photomask used for the manufacturing step shown in FIG. 1B.

FIG. 3 is a plan view of a further example of a photomask used for the manufacturing step shown in FIG. 1B.

FIG. 4A is a perspective view of a part of the reflective film shown in FIG. 1 on an enlarged scale, and

FIG. 4B is a perspective view of a part of a conventional reflective film on an enlarged scale.

FIG. 5 is a cross section of a liquid crystal display device according to the first embodiment of the invention.

FIG. 6 is a cross section of an optical reflector according to a second embodiment of the invention.

FIGS. 7A to 7D are schematic cross sections each showing a manufacturing step of an optical reflector according to a third embodiment of the invention.

FIG. 8 is a plan view of an example of a photomask used for the manufacturing step shown in FIG. 7B.

FIG. 9 is an illustration for explaining areas in the photomask shown in FIG. 8.

### DESCRIPTION OF THE PREFERRED EMBODIMENT(S)

Preferred embodiments of the invention will be explained in detail below with reference to the accompanying drawings.

### Embodiment 1

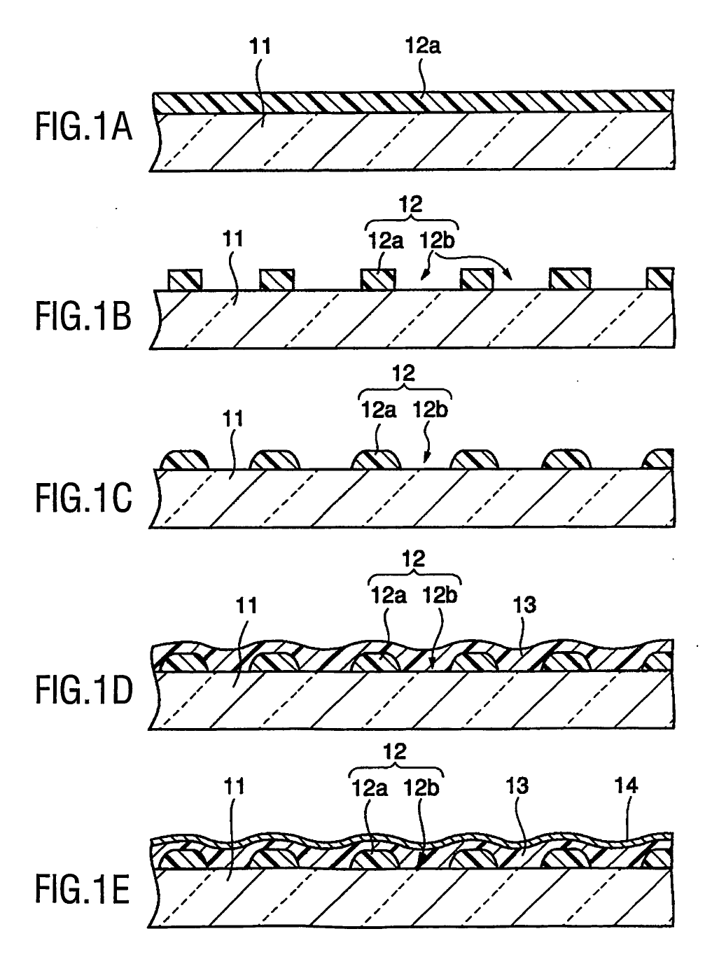

Referring to FIGS. 1 to 3, a method for manufacturing an optical reflector of a first embodiment of the invention will now be explained. An optical reflector of the embodiment of the invention implemented through the method for manufacturing an optical reflector of the embodiment will be described as well.

First, as shown in FIG. 1A, a support member 11 made of, for example, glass is prepared and a positive photoresist is then coated on the support member 11 to form a resist film 12a having a thickness of, for example, 1 to 3 microns, after of which the coated photoresist is baked (pre-baked). Subsequently, the resist film 12a is exposed using a photomask.

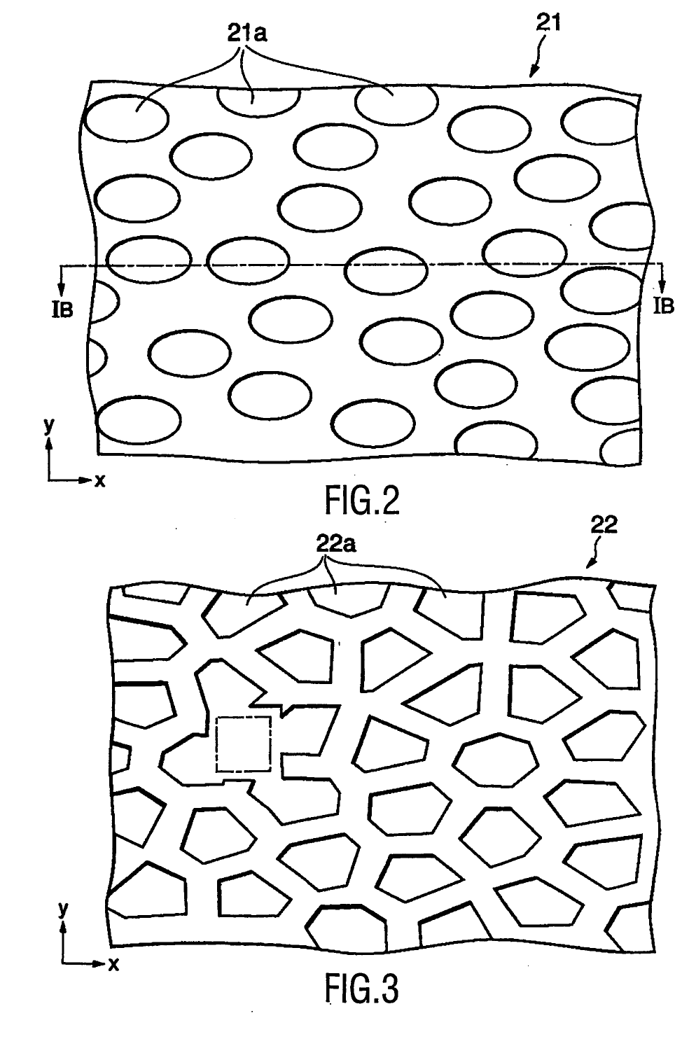

FIG. 2 is a plan view illustrating an exemplary photomask used for the exposure of the resist film 12a. The mask 21 has a plurality of openings 21a spaced apart from each other and those openings 21a each are shaped like an ellipse having a longer axis of, for example, 6 to 14 microns and a shorter axis of, for example, 3 to 7 microns. In the embodiment, the openings 21a may be identical or different in size, while they are substantially identical in the directions of the longer axis and the shorter axis. An average length of the longer axes of the openings (average diameter) may be 10 microns and an average length of shorter axes of the openings may be 5 microns. A pitch of the openings in their longer axis direction (the x direction of FIG. 2) is made wider than that in their shorter axis direction (the y direction of FIG. 2), the reason of which will be described later. In other words, the openings 21a are provided of higher density in their shorter axis direction.

Instead of the mask 21, a mask 22 as shown in FIG. 3 may be used for the exposure, which has polygonal-shaped openings 22a with the average diameters in the x and the y directions different from each other. A mask having elliptical openings and polygonal openings mixed may also be used. It is essential only that a mask can be used which has such openings as their average diameter and their average pitch in an x direction are larger than those in a y direction perpendicular to the x direction. Use of the mask 21 results in an advantage that a mask of simple structure can be used. The mask 22 is preferably used because it results in advantages that a tilt angle of projections (or depressions) of a later-described reflective film surface (see FIG. 1E) relative to the main surface of the support member can easily be controlled and the density of its openings becomes higher than the density of the elliptical openings. The average diameter of the openings in the x direction is selected, for example, 1.2 to 3.5 times, preferably at least 1.5 times as large as that in the y direction as well as the pitch of the openings in the x direction is selected, for example, 1.2 to 3.5 times, preferably at least 1.5 times as large as that in the y direction. The ratio between the average diameter in the x direction and the average diameter in the y direction is preferably the same as the ratio between the average pitch in the x direction and the average pitch in the y direction.

As shown in FIG. 1B which is associated with a cross sectional view taken along the line IB-IB of FIG. 2, the resist film 12a is developed after the exposure, so that part of the resist film 12a is selectively removed in correspondence with the openings of the mask and a plurality of depressions 12b are formed to provide a projection/depression forming member 12 consisting of the resist film 12a and the plurality of depressions 12b. Since the depressions 12b are in correspondence with the openings of the mask as described above, an average diameter thereof in the x direction (the right-and-left direction of FIG. 1B) is larger than that in the y direction (the direction vertical to the paper surface for FIG. 1B), and a pitch of the depressions in the x direction is greater than that in the y direction. The “x direction” and the “y direction” correspond to one specific example of a “first direction” and a “second direction” of the invention, respectively.

After the completion of the development, as shown in FIG. 1C, the resist film 12a is baked (post-baked) at a temperature of, for example, 200 C. or more for, for example, 0.5 to 1 hour. An upper end of the resist film 12a, i.e., an upper portion of each depression 12b is thus rounded. It should be noted that the post-baking in some cases makes the diameter of the depression 12b (the diameter at an interface between the depression 12b and the support member 11) in the x direction and the y direction change a little bit, but the change is substantially negligible.

Subsequently, as shown in FIG. 1D, a photoresist is coated on the support member 11 so as to cover the projection/depression forming member 12, providing a projection/depression adjustment film 13 with depressions and projections formed under the influence of the shape of the projection/depression forming member 12. The projection/depression adjustment film 13 is provided for adjusting the profile of depressions/projections of a later-described reflective film (see FIG. 1E). In more detail, the projection/depression adjustment film 13 is provided for adjusting a maximum tilt angle of the reflective film surface relative to the main surface of the support member 11 and for tilting the reflective film at the area of the film that corresponds to the depressions 12b so that the reflective film entirely has roughness.

After that, as shown in FIG. 1E, a metal material such as aluminum and silver is deposited on the projection/depression adjustment film 13 using, for example, the sputtering technique to form the reflective film 14 having a thickness of, for example, 100 nanometers or more, which reflective film 14 has depressions and projections formed under the influence of the depressions and projections of the projection/depression forming member 12 (and the projection/depression adjustment film 13). The optical reflector according to the invention is thus obtained in which the projection/depression forming member 12, the projection/depression adjustment film 13 and the reflective film 14 are formed on one surface of the support member 11. In this case, since the reflective film 14 is formed so as to follow the profile of the depressions 12b, the projections/depressions of the surface of the reflective film (reflecting surface) are made relatively wider in the x direction than in the y direction.

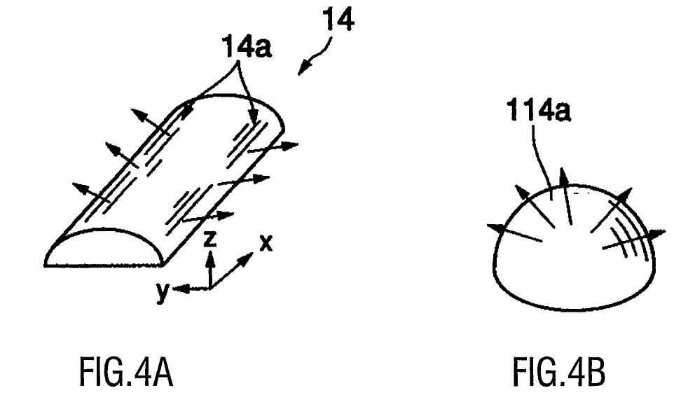

FIG. 4A is an enlarged schematic view of a part of the reflective film 14. A surface 14a of the reflective film 14 is inclined more richly in the y direction than in the x direction since the projections/depressions of the reflective film surface are formed relatively wider in the x direction than in the y direction and the pitch of said projections/depressions in the x direction is wider than that in the y direction as described above. As a result, when light rays are incident on the reflective film from a specific angle relative to the main surface of the support member 11, they are reflected in such a manner that larger part of the reflected light rays directs in the y direction to the direction substantially normal to the main surface of the support member 11 (the z direction of FIG. 4A). Thus, this embodiment different from the case where, as shown in FIG. 4B, the projections/depressions of a surface 114a of a reflective film are formed symmetrical (FIG. 4B shows one of them formed like a circle viewed from above a reflecting surface of a device) and light rays incident thereon are reflected uniformly in all directions. This means that the reflective film 14 has a directivity of reflection as a whole.

In this optical, since the reflective film 14 is formed on the projection/depression adjustment film 13, the reflective film 14 is rough all over the supporting member. In other words, the reflective film 14 is also tilted with respect to the main surface of the support member even on regions corresponding to each depression 12b in which the resist film 12a is not present. Consequently, the reflective film 14 has its surface 14a a larger part of which is inclined in the y direction, whereby the depressions of the reflective film surface also have the directivity of reflection. Mirror reflection caused in that region of the reflective film which is parallel to the support member and is not inclined can be reduced and a concentration of the reflecting light in an unfavorable direction caused by the mirror reflection can be suppressed.

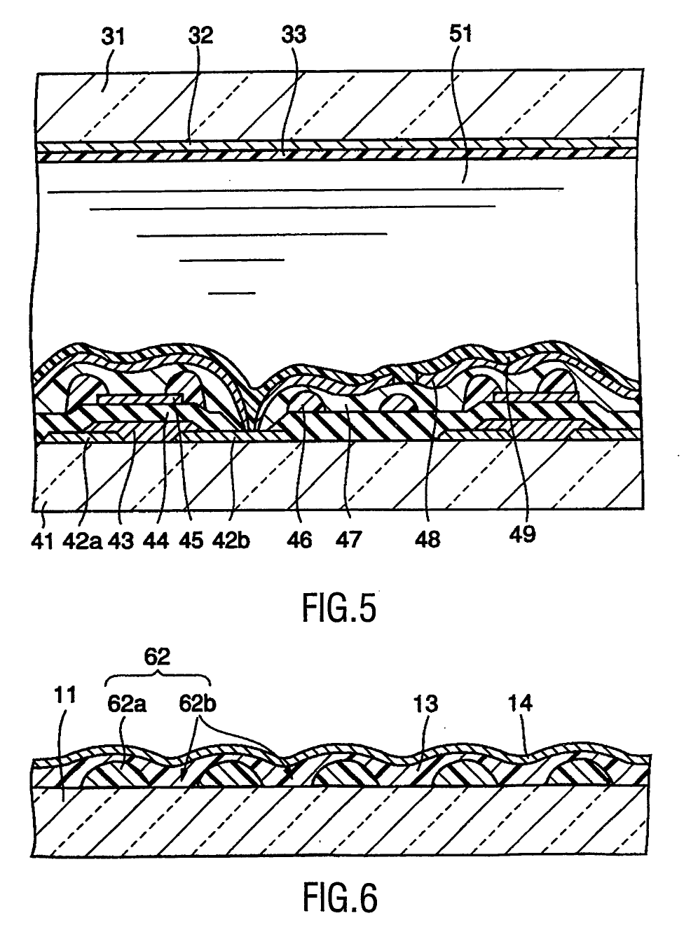

The optical reflector as described above is applicable to, for example, a so-called active matrix liquid crystal display device (LCD) using thin film transistors (TFT) as shown in FIG. 5.

The liquid crystal display device comprises an incident-side substrate 31 disposed to receive incident surrounding light and a reflective-side substrate 41 which is placed to oppose the incident-side substrate 31 with a given space in between, and a liquid crystal layer 51 is held between the incident-side substrate 31 and the reflective-side substrate 41. The incident-side substrate 31 is a transparent substrate made of, for example, glass and is provided with a color filter (not shown), a common electrode 32 and an orientation film 33 thereon. Although not shown in FIG. 5, the reflective-side substrate 41 is provided with a polarizer etc. thereon.

On a surface of the reflective-side substrate 41 are provided source electrodes 42a electrically connected to not-shown respective data lines and drain electrodes 42b, with each pair of the two electrodes 42a and 42b being spaced apart from each other. Semiconductor layers 43 are disposed adjacent to the respective source electrodes 42a and the respective drain electrodes 42b. On a side of the reflective-side substrate 41 opposite the semiconductor layers 43, gate electrodes 45 electrically connected to the not-shown respective scanning lines are formed via a gate insulation film 44 having openings. Thus, the reflective-side substrate 41 is provided with TFTs thereon. On the gate insulation films 44 and the gate electrodes 45 is provided a projection/depression forming member 46, which is patterned by the same manner as the projection/depression forming member 12. On the pattern of the projection/depression forming member 46 is provided a projection/depression adjustment film 47 having opening. On the projection/depression adjustment film 47 is formed a reflective film (reflective electrode) 48 also serving as a pixel electrode. The reflective film 48 is electrically connected to, for example, the drain electrodes 42b via the openings of the projection/depression adjustment film 47 and the gate insulation film 44 thereby to apply a voltage to the reflective film by means of the TFTs. On the reflective film 48 is formed an orientation film 49.

The liquid crystal display device constructed as described above will operate as follows.

In the liquid crystal display device, surrounding light rays enter the incident-side substrate 31 and pass through the not-shown color filter, the common electrode 32, the orientation film 33, the liquid crystal layer 51 and the orientation film 49 to reach the reflective film 48. The light rays are then reflected by the reflective film and pass through each of the said layers (films) to exit from the incident-side substrate 31. After that, the light rays are to be displayed in the black display state when a voltage is applied between the common electrode 32 and the reflective film (pixel electrode) 48 (on state), while to be displayed in the white display state when a voltage is not applied between them (off state). Although a device operating in a so-called normally white mode has been explained, this invention may, of course, be applicable to a device operating in a reverse mode, i.e., in a so-called normally black.

Since the incident light rays are reflected by means of the reflective film 48 with the above-mentioned directivity of reflection, when an image displayed on a not-shown display surface of the device is viewed from a position approximately vertical to the display surface, or the display surface of the device is viewed from above, a ratio of an amount of the effectively reflected light rays to a total amount of the incident light rays is large, meaning that the incident light rays are very efficiently utilized. Since mirror reflection at the reflective film 48 is effectively suppressed as described above, glare of the display surface can be prevented.

With the optical reflector according to this embodiment, the directivity of reflection at the reflective film 14 is exhibited over the whole area of the reflective film 14, so that a ratio of an amount of light rays reflected in the y direction to an amount of light rays incident on the reflective film 14 can be made large when light rays are incident on a surface of the reflective film 14 at a specific angle relative to the display surface of the device. The optical reflector of the embodiment can be advantageously manufactured by the same method as the conventional one except for changing from the conventional mask used for the exposure of the resist film to the mask, for example, as shown in FIG. 2 or 3.

In addition, since the projection/depression adjustment film 13 is formed between the projection/depression forming member 12 and the reflective film 14, roughness in the whole of the reflective film can be easily applied. As a result, the inclination of the reflective film surface in the y direction can be provided more effectively. The presence of the projection/depression adjustment film 13 causes the mirror reflection of the incident light rays to be reduced.

Therefore, if a reflective display device is constructed using the above-mentioned optical reflector, a large amount of the incident light rays can be reflected diffusely in a desired direction, enhancing a utilization of the incident light rays when viewing a display surface of the devise from a position located in a specific direction with respect thereto. More specifically, for example, when viewing an image of a portable telephone from a position approximately vertical to a display surface thereof, a large amount of the incident light rays can be reflected diffusely in the up-and-down direction (the y direction) of the display surface thereby to improve display performance of the device such as brightness and contrast. In addition, reflection of the incident light rays in the left-and-right direction (the x direction) of the display surface could be effectively reduced, so that the device is advantageous, for example, when the contents to be hidden from the view of others is displayed.

### Embodiment 2

FIG. 6 illustrates a cross sectional structure of an optical reflector of a second embodiment of the present invention. This optical reflector is the same in configuration as that of the first embodiment except for the configuration of the projection/depression forming member. Therefore, the projection/depression forming member 62 will be described in detail hereinafter.

The projection/depression forming member 62 is manufactured using a mask with a pattern, for example, obtained by inverting the pattern of the mask 21 shown in FIG. 2. The projection/depression forming member 62 has projections 62a made of a resist film and the remainder of the projection/depression forming member 62 is defined as removal portions 62b where the resist film has been removed. In this embodiment, a reflective film 14 is formed to follow the shape of the projections 62a, so that an average diameter of projections 14a of the reflective film 14 in the x direction is larger than that in the y direction projections/depressions of a reflective film surface are made relatively wider in the x direction than in the y direction. Needless to say, the projection/depression forming member 62 may be manufactured using a mask with a pattern obtained by inverting the pattern of the mask 22 shown in FIG. 3.

With the optical reflector according to this embodiment, it has directivity of reflection all over the area where the reflective film 14 is present, resulting in an increased ratio of an amount of light rays reflected in the y direction to a total amount of the incident light rays when the incident light rays are reflected on the surface of the reflective film 14. Therefore, a reflective display device constructed using the optical reflector leads to its improved display performance such as brightness and contrast as is the case with the first embodiment.

In the first and second embodiments, the projection/depression forming member 12, 62 is patterned and then the photoresist is coated to form the projection/depression adjustment film 13. Alternatively, the following manufacturing process may be employed. The photoresist is coated more thickly (for example, 2 to 4 microns) on the support member 11, a single-piece of the projection/depression forming member 12, 62 and the projection/depression adjustment film 13 is formed by exposing the photoresist while adjusting a light exposure amount (half exposure) so that part of the photoresist correspondings to the depressions 12b is melt to have a desired depth from the their top and the shape. This process reduces the number of steps required for the manufacture of the optical reflector.

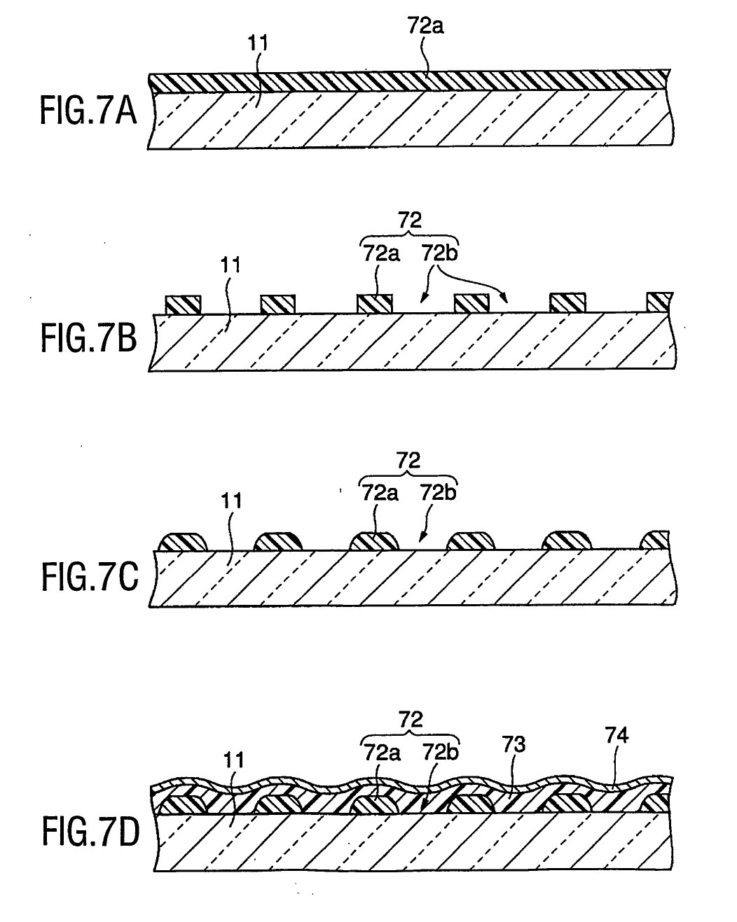

In the case where an organic material such as the photoresist is used for the projection/depression forming member, the organic material exhibits high fluidity with heating the projection/depression forming member for the post-baking or the like. This may cause the pattern of the depressions or the projections of for the projection/depression forming member to differ from a desired pattern. Particularly, when using a low-cost organic material without a cross-linking agent such as a thermal cross-linking agent, its fluidity would become higher with heating, so that a desired pattern of the depressions or the projections of for the projection/depression forming member could not be obtained. Another method for manufacturing of an optical reflector will now be described with reference to FIGS. 7 to 9 in which such an unfavorable possibility could be prevented.

### Embodiment 3

This embodiment relates to an optical reflector, a method for manufacturing the same and a liquid crystal display using the optical reflector. The optical reflector of the embodiment of the invention will be implemented through the method for manufacturing the optical reflector of the embodiment.

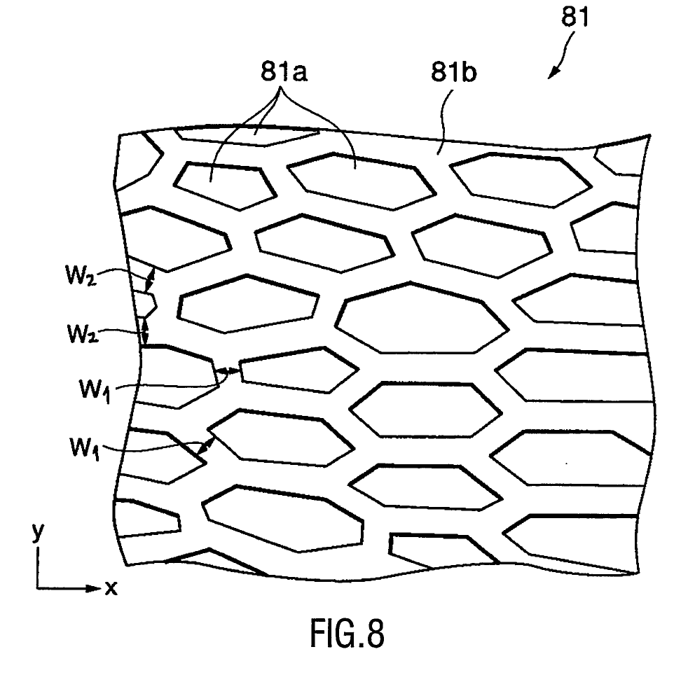

FIGS. 7A to 7D show manufacturing steps of an optical reflector according to a third embodiment of the invention. In this embodiment, as shown in FIG. 7A, a resist film 72a is formed on the support member 11 and then pre-baked in the same manner as described for the first embodiment. Subsequently, the resist film 72a is exposed using a photomask, for example, shown in FIG. 8.

A photomask 81 shown in FIG. 8 has substantially polygonal openings 81a in a mesh manner. That portion 81b of the photomask 81 by which the mesh-patterned openings 81a are formed, i.e., the other part than the openings 81a of the photomask 81, is formed such that a width W₁ of said portion 81b in a later-described region (first region) is made larger than a width W₂ of said portion 81b in another later-described region (second region). Said first region includes a direction perpendicular to a direction where light rays incident on the reflective film are to be reflected in a large amount by the reflecting surface of the reflective film 14 (see FIG. 7D) and a part in which any direction forms a predetermined angle with the above-mentioned direction. The second region is a region other than the first region of the portion 81b of the photomask 81. The width W₁ may be 3 to 8 microns and the width W₂ may be 2 to 7 microns. These widths W₁, W₂ each may be not same at every location necessarily, but they must be W₁>W₂. An average diameter of the openings 81a of the photomask 81 in the x direction is larger than that in the y direction. Preferably, an average pitch of the openings 81a of the photomask 81 in the x direction is greater than that in the y direction.

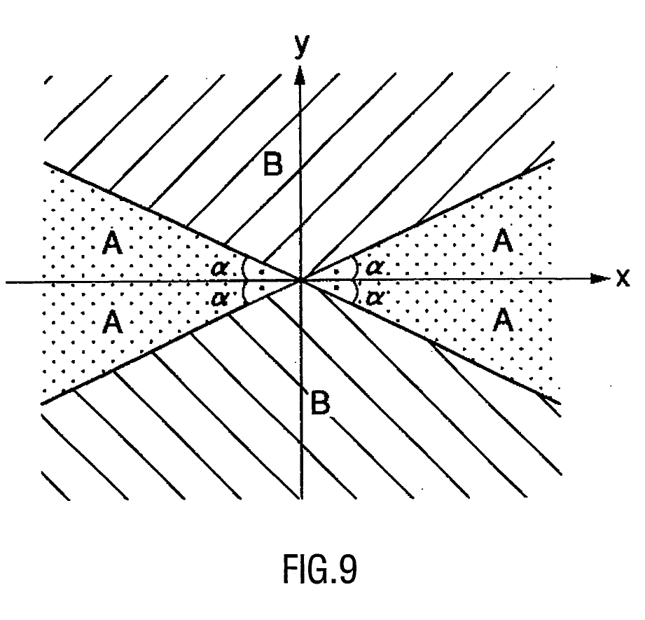

The width of the pattern forming portion 81b of the photomask 81 is determined in accordance with a ratio of an average pitch of the openings 81a in the x direction to that in the y direction. In more detail, in a case where a ratio of an average pitch of the openings 81a in the x direction to that in the y direction (x:y) is p:1, as shown in FIG.9, the width W₁ in the first region A of the pattern forming portion 81b, which forms an angle “alpha”, α=tan⁻¹(1/p) ) (0 degree □alpha □ 180 degrees), with the x-axis, is larger than the width W₂ in the second region B other than the first region A of the portion 81b. The reason why a boundary angle alpha is decided in accordance with said ratio between two average pitches is as follows. With the average pitch of the openings 81a in the x direction being larger than that in the y direction, If the alpha is simply selected to be 45 degrees, a ratio of a part of the portion 81b extending to the substantial x direction to apart of the portion 81b extending to the substantial y direction is larger, so that an advantageous effect cause by the difference of the width in the portion 81b is less. If the said ratio of the portion 81b extending to the substantial x direction and the substantial y direction is 1, non-symmetry of the width of the portion 81b causes said effect to be increased.

After the exposure of the resist film 72a, the resist film is developed. Thus, as shown in FIG. 7(B), depressions 72b corresponding to the openings 81a of the photomask 81 are formed in a mesh manner, resulting in a projection/depression forming member 72 consisting of the resist film 72a as projections and the depressions 72b. In those steps of exposing the photoresist and developing thereof it would appear that the width of the resist film 72a changes a little bit in relation to the width of the corresponding portion of the photomask 81, but the change occurs over the entire projection/depression forming member 72. Therefore, even if the absolute value of width of the resist film 72a is changed, a ratio of the width in the x direction to that in the y direction keeps substantially unchanged.

After the development of the resist film 71a, as shown in FIG. 7C, post-baking is performed at a temperature of, for example, 180 degree C. or more. In this step, the organic material such as photoresist temporarily undergoes a high fluidity state with heating and rises up higher in proportion to the area over which the organic material is coated. The width of the resist film corresponding to the first region A (see FIG. 9) of the portion 81b of the photomask 81 (hereinafter, this area is also referred to the “first region”) is formed relatively wider and when heating the resist film in the post-baking step, the resist film corresponding to the first region of the portion 81b rises up higher than the resist film corresponding to the second region B thereof. That is, the resist film corresponding to the first region A of the portion 81b is made higher than the resist film corresponding to the second region B thereof. The height of the resist film 72a in the first region A may be 2-4 microns and that in the second region B may be 0.6-1.4 microns.

After that, a projection/depression adjustment film 73 and a reflective film 74 are formed as in the case of the first embodiment. Thus, an optical reflector having the projection/depression forming member 72, the projection/depression adjustment film 73 and the reflective film 74 formed on one surface of the support member 11 is obtained as shown in FIG. 7D.

In the optical reflector obtained as described above, projections of the reflective film 74 follow the projections 72 of the projection/depression forming member 72, so that the height of the projections of the reflective film 74 in the first region is higher than that in the second region and a tilt angle of the projections of the reflective film 74 relative to the main surface of the support member in the first region is larger than that in the second region. A part of the tilting surface of the reflective film 74, where the surface extends in the substantial x direction and tilts in the substantial y direction, is present more than the other part of the tilting surface of the reflective film 74, where the surface extends in the substantial y direction and tilts in the substantial x direction. Therefore, a larger part of the light rays incident on the optical reflector is reflected in the substantially y direction. Consequently, the light rays reaching the reflective film 74 are reflected with directivity of reflection being exhibited in the substantial y direction.

The optical reflector with such a configuration is also applicable to the above-described liquid crystal display device or the like.

With the optical reflector of this embodiment, when the organic material to form the projection/depression forming member 72 exhibits high fluidity with heating after the application thereof, it can be formed to have a desired shape. Therefore, even when a low cost material without a heat curable agent or the like is used as a material for the projection/depression forming member 72, the optical reflector constituted by such a low cost material could have a directivity of reflection.

Although the invention has been described with reference to the embodiments thereof it will be understood that the invention is not limited to the above-mentioned embodiments but can be modified differently. For example, the above embodiments have described the case where an average diameter of the depressions 12b or the projections 62a of the projection/depression forming member 12, 62 in the x direction is made larger than that in the y direction, and the pitch of the depressions 12b or projections 62a in the x direction is made greater than the that in the y direction. However, the depression 12b and the projection 62a may be provided such that said average diameter in the y direction is made larger than that in the x direction, and said pitch in the y direction is made greater than that in the x direction. Such as optical reflector is advantageous, for example, when a plurality of persons view the same display surface of a display device, requiring the display device to exhibit superior visual performance in the left-and-right direction (the above-stated x direction) of its display surface.

The above embodiments have described the case where the depressions 12b are formed so that the their pitch in the x direction is made greater than the that in the y direction by using the mask with the openings that the pitch of the depressions 12b or projections 62a in the x direction is made wider than the that in the y direction. However, the effects of the present invention can also be obtained when the depressions 12b are formed to have an average pitch greater in the x direction than in the y direction.

The above second embodiment has described the case where the projection/depression forming member 62 is formed using the mask with the pattern obtained by inverting the pattern of the mask 21 shown in FIG. 2. However, the projection/depression forming member 62 may be formed using negative photoresist and the mask 21. It should be noted that the positive photoresist is preferable to the negative photoresist because the positive photoresist is superior to the negative photoresist in controllability of said tilt angle relative to the main surface of the support member 11 after post-baking of photoresist.

The above embodiments have described the case where the projection/depression adjustment film 13 is formed between the projection/depression forming members 12, 62 and the reflective film 14. However, it is not necessarily required, and alternatively, the projection/depression forming member 12 or 62 may be provided with the reflective film 14 thereon directly. In addition, in the third embodiment, the projection/depression forming member 72 and the projection/depression adjustment film 73 may be integrally formed through the use of the half exposure. When the half exposure is performed in manufacturing the optical reflector, fluidity of the photoresist may be increased by heating the projection/depression forming member. For this reason, the method described in the third embodiment is particularly effective at causing the optical reflector to high directivity of reflection.

Although the above third embodiment has described its effects and advantages by taking the post-bake as an example, the invention is also effective with any heating following the exposure/development step other than the post-bake.

Although the above embodiments have described the case where the liquid crystal display device has the reflective film 48 that serves as not only a reflective electrode but also a pixel electrode, the optical reflector of the present invention may be applicable to a liquid crystal display device independently having a pixel electrode and a reflector.

In the above embodiments, the TFTs 17 are used as switching elements, but it is also possible to use other switching elements such as MOSFETs (metal oxide semiconductor field effect transistor). Moreover, the above embodiments have described the case of a so-called active matrix drive type device using switching elements, but the optical reflector of the present invention is also applicable to a so-called passive matrix drive type device without using any switching elements.

The above embodiments have described the case where the optical reflector is used for the reflective liquid crystal display. However, it may alternatively be used a liquid crystal display with a mixed construction of a reflective part and a transmissive part, or a liquid crystal display which has a thin reflective film to reflect part of light rays and transmit part of light rays.

1. An optical reflector comprising:
a projection/depression forming member provided on one surface of a support member and having a plurality of depressions or projections which are spaced apart from each other; and
a reflective film provided so as to cover said projection/depression forming member and having a reflecting surface with depressions and projections formed under the influence of the depressions or projections of said projection/depression forming member,
said optical reflector characterized:
in that an average diameter of the plurality of depressions or projections of said projection/depression forming member in a first direction is larger than that in a second direction which is perpendicular to said first direction; and
in that the plurality of depressions or projections of said projection/depression member are provided in such a manner that an average pitch thereof in said first direction is greater than that in said second direction.

2. An optical reflector as claimed in claim 1, characterized in that a projection/depression adjustment film is provided between the projection/depression forming member and the reflective film to adjust the depressions and projections of the reflecting surface.

3. An optical reflector as claimed in claim 1, characterized in that a cross-sectional shape of each depression or projection of said projection/depression forming member in a plane parallel to said one surface of said support member is elliptical.

4. An optical reflector as claimed in claim 1, characterized in that a cross-sectional shape of each depression or projection of said projection/depression forming member in a plane parallel to said one surface of said support member is polygonal.

5. An optical reflector as claimed in claim 4, characterized in that the plurality of depressions or projections of the projection/depression member is formed by projections or depressions which make a mesh pattern of the projection/depression forming member, a width of the projections or depressions which make the mesh pattern of the projection/depression forming member in a first region where any direction forms a predetermined angle with said first direction being larger than that in a second region other than the first region.

6. An optical reflector as claimed in any one of claims 1, characterized in that the depressions or projections of the projection/depression member is formed by projections or depressions which make a mesh pattern of the projection/depression forming member, a height or a depth of the projections or depressions which make the mesh pattern of the projection/depression forming member in a first region where any direction forms a predetermined angle with said first direction being larger than that in a second region other than the first region.

7. An optical reflector as claimed in any one of claims 1, characterized in that the average diameter of the plurality of depressions or projections of said projection/depression forming member in the first direction is at least 1.5 times as large as that in the second direction.

8. An optical reflector as claimed in any one of claims 1, characterized in that the average pitch of the plurality of depressions or projections of said projection/depression forming member in the first direction is at least 1.5 times as great as that in said second direction.

9. An optical reflector comprising:
a projection/depression forming member of an organic material provided on one surface of a support member and having projections or depressions which make a substantially polygonal mesh pattern of said projection/depression forming member; and
a reflective film provided so as to cover said projection/depression forming member and having a reflecting surface with projections or depressions formed under the influence of the projections or depressions of said projection/depression forming member,
said optical reflector characterized in that a width of the projections or depressions of the projection/depression forming member in a first region where any direction forms a predetermined angle with one direction in plane with a plane parallel to the one surface of the support member and that in a second region other than the first region in plane with the plane parallel to the one surface of the support member are different from each other.

10. An optical reflector as claimed in claim 9, characterized in that said one direction is orthogonal to a direction to which a larger amount of light rays are to be reflected on the reflecting surface of the reflective film, the width of the projections or depressions of the projection/depression forming member in the first region is larger than that in the second region.

11. An optical reflector as claimed in claim 10, characterized in that the projections or depressions of said projection/depression member are provided in such a manner that an average diameter of the depressions or projections formed by the projections or depressions of the said projection/depression member in said one direction is larger than that in an orthogonal direction orthogonal to said one direction.

12. An optical reflector as claimed in any one of claims 9, characterized in that the projections or depressions of said projection/depression member are provided in such a manner that an average pitch of a plurality of depressions or projections formed by the projections or depressions of the said projection/depression member in said one direction is greater than that in said orthogonal direction.

13. An optical reflector as claimed in claim 12, characterized in that said predetermined angle is determined in accordance with a ration of the average pitch of the depressions or projections of the projection/depression forming member in the one direction to that in the orthogonal direction.

14. An optical reflector as claimed in any one of claims 9, characterized in that a height or a depth of the projections or depressions of said projection/depression member in the first region is larger than that in the second region.

15. A display device comprising an optical reflector as claimed in 1.
